(19) United States
(12) Patent Application Publication
(10) Pub. No.: US 2004/0041916 A1
(43) Pub. Date: Mar. 4, 2004

(54) Equipment for extracting freely definable image sections from an image sensor

(76) Inventor: Nikolaus Schibli, (US)

Correspondence Address: BLANK ROME LLP, 600 NEW HAMPSHIRE AVENUE, N.W., WASHINGTON, DC, 20037, US

(21) Appl. No.: 10/654,882

(22) Filed: Sep. 5, 2003

Related U.S. Application Data
(63) Continuation of application No. PCT/CH02/00140, filed on Mar. 7, 2002.

(30) Foreign Application Priority Data
Mar. 9, 2001 (CH) CH0436/01

(51) Int. Cl. H04N 5/225

(52) U.S. Cl. 348/207.99

(57) ABSTRACT

Electronic equipment (for example a camera) having an image-reading unit, and at least one image sensor. The image-reading unit (1) is provided with one or several image sensors (6), and the at least one image sensor allows access to individual pixels. The image-reading unit (1) is designed in such a manner that it can receive and execute image recording orders. The shape of the image section (60) that is to be extracted from said image sensor (6) is freely definable in at least one of the image recording orders. The image-reading unit (1) reads in and makes available only the image sections (60) of the image sensor (6) that correspond to the shape freely defined in the image recording order.

### REFERENCE DATA

This application is a continuation of PCT/CH02/00140, filed on Mar. 7, 2002 and claiming priority from CH0436/01, filed Mar. 9, 2001.

### FIELD OF THE INVENTION

The present invention concerns an electronic equipment, in particular an intelligent digital camera with which freely definable image sections can be extracted from an image sensor.

### DESCRIPTION OF RELATED ART

Special camera systems consisting of several elements are used nowadays for digitally processing images for industrial processes, medical technology, video systems etc. Such a system consists of an image sensor provided with an optic. This image sensor is capable of recording images and of storing these in a digital memory. The pixel signals generated by the image sensor are converted into digital image data over an analog-to-digital converter. The image sensor (for example in CDD, CMOS or CID technology) must be controlled with special signals in order to extract the pixel values. A processor is often provided that is capable of processing the digital image data with algorithms and programs. The result of the image data processing is transmitted over a communication interface to an external computer unit (for example to a control system, an actuator, etc.). Such camera systems, which are fitted with a processor capable of processing image data, are called intelligent cameras.

Intelligent cameras are often used as intelligent sensors in a closed regulator circuit. The result of the image data processing must be delivered within the shortest possible throughput time to a processing computer capable of influencing the filmed system. The shorter the throughput time and the processing time, the shorter the sampling time of the regulator circuit can be chosen. In this manner, the regulator system becomes more efficient and faster.

This means for the intelligent camera that the processor must process the image data as fast as possible. The processing time is however dependent on the amount of the image data that must be processed. If the resolution and/or the size of the image sensor are increased, a slower image data processing must be expected. It is thus necessary to find a compromise between the camera's resolution (number of transmitted pixels), the throughput time and the price. Existing intelligent cameras have either a low resolution (image quality), a slow speed (throughput time) and/or a high price and are thus suitable only for certain purposes.

One aim of the present invention is thus to propose a new electronic equipment, in particular a camera with which a better compromise can be achieved between resolution, speed and price.

Another aim of the invention is to propose a new electronic equipment with which the compromise between resolution and speed can be modified at any time by the user.

### BRIEF SUMMARY OF THE INVENTION

According to the invention, these aims are achieved in that a new electronic equipment makes available at any time as fast as possible only the necessary image data (instead of all image data from the image sensor). Special pre-defined image shapes (for example rectangles, circles, lines, patterns, etc.) can be extracted. By not extracting the entire image from the image sensor but only freely definable image sections, the image data can be read and further processed considerably faster without having to accept a reduction of the image quality for the selected image part.

These aims result also from an electronic equipment comprising the following elements:

an image-reading unit, provided with one or several image sensors, at least one image sensor allowing single-pixel access,

said image-reading unit being designed in such a manner that it can receive and execute image recording orders,

the shape of the image section that is to be extracted being defined in at least one of said image recording orders,

and said image-reading unit reads in and makes available only the pixels of said image sensor corresponding to the shape defined in said image recording order.

In this way, an external electronic equipment requesting image data can determine itself with corresponding image recording orders the shape and size of the recorded image section and, in this manner, influence the speed of the image data processing.

The electronic equipment according to the invention preferably uses at least one image sensor allowing single-pixel access. Image sensors with single-pixel access as such are already known and are even available on the market. An example of such a sensor is described among others in patent application EP-A2-935880 that proposes a semi-conductor circuit for quickly reading in individual pixels. Another example is described in patent U.S. Pat. No. 5,933,190. This document describes an image sensor topology of the CMOS technology that also allows access to single pixels rather than only to entire images. In order to access an image section (image area) with such a sensor, an external device must address each pixel of the image section separately, which presupposes a high computer capacity of said external device.

U.S. Pat. No. 5,146,340 describes an image reading and processing system that allows an electronic image sensor to read in with two different speeds. This is done to read in a chosen image zone with the correct speed whilst the rest of the image is read in with an increased speed in order to reach the interesting image part more quickly. The unneeded sections of the image are not digitized. This method makes it possible to increase the clock frequency of the image reading-in process. The read-in image is stored in an image memory. After switching the buses, this image memory can be read in and processed by a processor. All the pixels, also those that are not at all needed, are read in.

U.S. Pat. No. 5,060,074 proposes an image-reading unit for a video camera, which, like in patent U.S. Pat. No. 5,146,340, enables the image field to be read in with two different speeds. This is done in order to read in an interesting image zone faster than the entire image. In this manner, the vibrations of the image caused by the camera user can be compensated. The interesting image zone can be represented without vertical or horizontal shifting. Again, all the pixels are always read in.

### BRIEF DESCRIPTION OF THE DRAWINGS

Preferred embodiments of the invention will be described hereafter in more detail with the aid of the attached figures, in which:

FIG. 1 shows a simple diagrammatic representation of an equipment according to the invention, divided in an image-reading unit, a memory unit and an external electronic device.

FIG. 2 shows a diagrammatic representation of a first embodiment of an equipment according to the invention.

FIG. 3 shows a diagrammatic representation of a second embodiment of an equipment according to the invention (in this example as an intelligent camera).

FIG. 4 shows a diagrammatic representation of a third embodiment of an equipment according to the invention, with a PC comprising a frame-grabber card having DMA PC memory access and with a single-pixel access camera.

FIG. 5 shows a diagrammatic representation of a fourth embodiment of an equipment according to the invention, with a single-pixel access camera having a fast communication interface, which sends the requested pixels directly and without intermediary storage to an external electronic equipment.

FIG. 6 shows a diagrammatic representation of a fifth embodiment of an equipment according to the invention, with a PC comprising a frame-grabber card having a buffer memory and with a single-pixel access camera.

FIG. 7 shows a diagrammatic representation of the parameters that are required in an image recording order for defining a rectangular image section.

FIG. 8 shows a diagrammatic representation of the parameters that are required in an image recording order for defining an image section in the shape of a parallelogram.

FIG. 9 shows a diagrammatic representation of the parameters that are required in an image recording order for defining an elliptical image section.

### DETAILED DESCRIPTION OF THE INVENTION

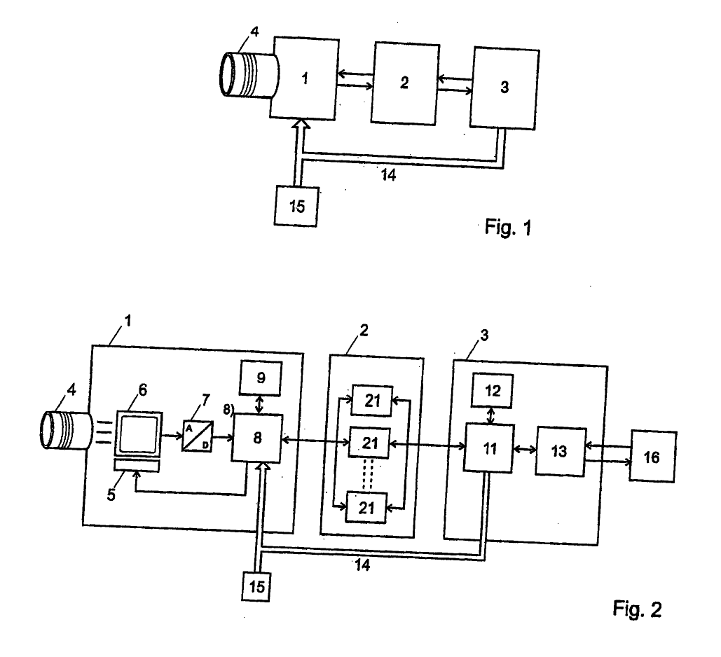

FIG. 1 shows an image signal processing system with three elements 1, 2 and 3. The reference number 1 represents diagrammatically an image-reading unit that can write video image data recorded by means of an optic 4 into a memory unit 2. The image-reading unit 1 can preferably also read the contents of the memory unit 2. The image-reading unit 1, the optic 4 and the memory unit 2 are preferably lodged in the same camera housing (not represented). An external electronic unit 3 (for example a PC, a video recorder or a process computer) can access the image data in the memory unit 2 over a communication interface and preferably also write data (among others image recording orders) in this unit.

The external electronic equipment 3 can request from the image-reading unit 1, by means of orders written in the memory unit and/or by means of a synchronization signal over the communication interface 14, that writes a section of the entire image with a defined shape in the memory unit 2. Synchronization signals can also originate from any external device 15. The image-reading unit comprises an image sensor that can access each individual pixel directly. This allows the image-reading unit to store special image shapes such as rectangular shapes, circles, several parallel lines and any other image shape in the memory unit 2 without having to read in unused pixels. Since only the needed pixels are read in, the reading-in and processing time of the image-reading unit is considerably reduced. The camera with the units 2 and 3 thus makes available only those pixels that belong to the image shape determined by the external equipment 3, 15. The image frequency depends on the size and kind of the required shape so that an external device 3, 15 can itself increase the image frequency, for example by having a smaller image section extracted.

The image-reading unit 1 comprises programmable data processing means, which will be described further below, for generating the address and timing signals controlling the driver of the image sensor according to the requested image section. These processing means can preferably also use certain image processing algorithms for image processing, for example in order to calibrate images, to eliminate a permanent noise, to binarize images with a threshold value, to determine outlines in the image or to follow objects in an image sequence. The processing means in the image-reading unit preferably comprise a microprocessor and/or a digital signal processor (DSP) for executing these algorithms. New programs can be loaded over the memory unit 2, over another interface or on a data carrier (for example a PC card). For the calibration, a calibration image stored in an electronic memory can be used. When an order of synchronization signal to record an image is received, the chosen image data are addressed and calibrated with the calibration image before the new image data become available as calibrated images.

FIG. 2 shows a detailed representation of a first embodiment of an equipment according to the invention. The image-reading unit 1 with data processing means 8, 9 and the memory unit 2 are preferably integrated within the same housing. Such a combination is called an intelligent camera, since the camera can perform certain image signal processing steps without an external processor.

The image-reading unit 1 consists of an image sensor 6 with single-pixel access, of an optic 4 for focusing light, of a driver 5 and of an analog-to-digital converter 7. Programmable data processing means 8 (for example one or several processors and/or DSP, or a FPGA circuit) generate the addresses and the timing signals that control the driver 5 in such a manner that only the needed pixels are read in the image sensor 6. Other image processing operations can be carried out (for example an image calibration, the binarization of the image, the computation of outlines, a high pass or low pass filtering, or the following of objects in successive images of an image sequence). The data processing means 8 use a local electronic memory 9 (for example a RAM) in order to execute the different programs.

The memory unit 2 consists in this embodiment of several memory modules 21. In this way, the image-reading unit 1 can access a memory module while the electronic equipment 3 simultaneously accesses another module.

Only the needed pixels are read in by the image sensor 6 with the driver 5 and digitized with the analog-to-digital converter 7 and written either in the internal memory 9 or directly in a memory 21 of the memory unit 2. The image recording is performed on an order or a synchronization signal 14 given to the processor 8. This order can originate from the processor 11 of the external equipment 3 but also from another external device 15.

The external electronic equipment 3 consists here of a processor system that reads and further processes the selected image data from the memory modules 21 of the memory unit 2. This processor system 3 can communicate to the image-reading unit 1, over a communication interface 14 or over the orders stored in the memory unit 2, which image section is needed. It is however also possible for the image recording orders to come from another external equipment 15 or to be generated by the image-reading unit 1 itself. The image processing unit 3 can read the image data in the memory unit 2 and store them in a local memory area 12. Further digital processing means 11 are preferably provided for managing the image data and for sending them over a communication interface 13 to an external device 16.

A communication protocol is preferably provided for defining the image recording orders that are sent from the external electronic equipment 3 to the image-reading unit 1 in order to access a certain area of the image sensor 6. These orders must be flexible, easy to understand for the programmer and quickly interpretable by the data processing means 8. It should be possible to enter with these orders all image acquisition modes supported by the image-reading unit 1. An order interpreter (for example a suitable program executed by the processor 8) interprets these orders and access the pixels of the image sensor 6 belonging to the selected image section by generating in real time the addresses and timing signals for the driver 5 required for extracting the pixels.

The image-reading unit 1 can support at least the following image reading-in modes. Each mode is launched with a corresponding image recording order:

1. Extracting Rectangular Image Windows in Rectangle Mode

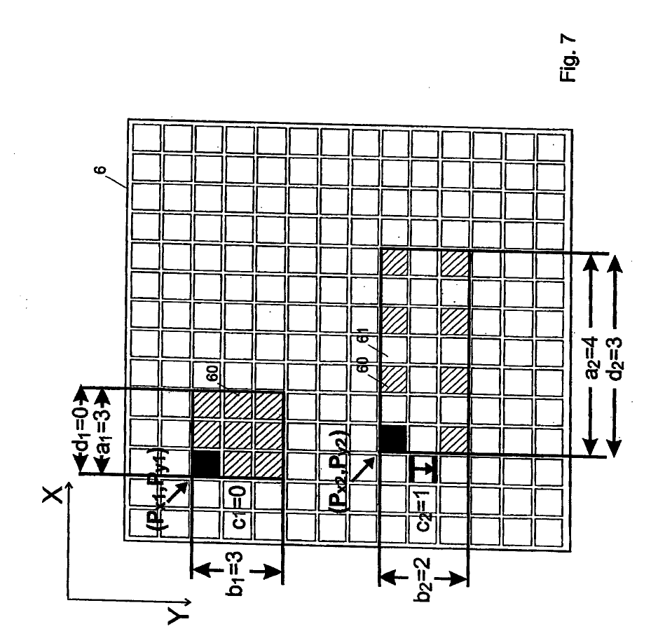

This reading-in mode is represented diagrammatically in FIG. 7. In this figure, the pixels 60 to be read in are sharpened while other pixels 61 are represented in white. This mode allows a certain number (1 up to a maximum number) of rectangular image surfaces from the image sensor 6 to be read in. In this mode, the entire image surface can also be read in. All the pixels of the rectangles can be read in; in a variant embodiment, it is also possible to skip a certain number of lines resp. columns at regular intervals in the horizontal direction X resp. in the vertical direction Y. In the represented example, only every other column and only every line of the second largest rectangle are read in. These gaps allow the selected image sections to be read in with a reduced resolution. The resolution of each image section can be chosen differently. The ratio between the number of skipped and read pixels in each direction is defined as down-sampling factor.

Such parameters can be entered in the image recording orders to select the reading-in in rectangle mode:

1. Number of rectangles to be read in (in the represented example 2)

2. Horizontal coordinates Pxi of the first pixel (a corner pixel of the rectangle) of each rectangle i

3. Vertical coordinates Pyi of the first pixel (a corner pixel of the rectangle) of each rectangle i

4. Number ai of read lines in the horizontal direction X for each rectangle i. The parameter ai must be greater than zero

5. Number di of unread lines in the horizontal direction X for each rectangle i

6. Number bi of read columns in the vertical direction Y for each rectangle i. The parameter bi must be greater than zero

7. Number ci of unread columns in the vertical direction Y for each rectangle i.

2. Extracting a Parallelogram-Shaped Image Window in Parallelogram Mode

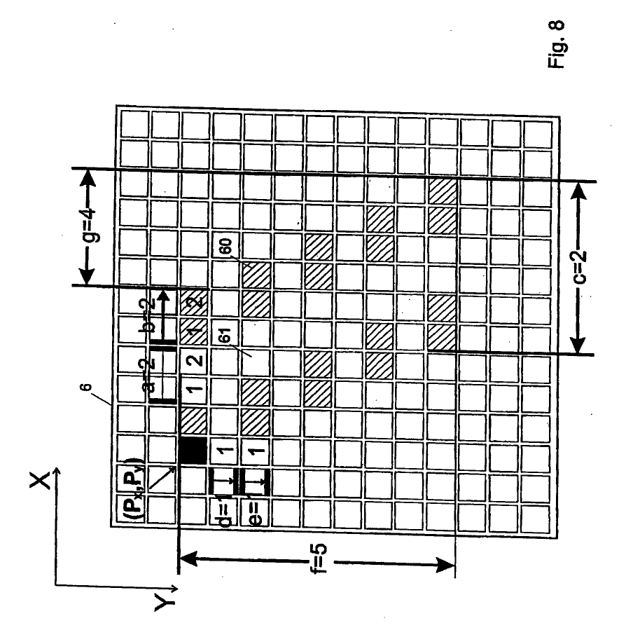

This reading-in mode is represented diagrammatically in FIG. 8. This mode allows a certain number (1 to a maximal number) of parallel lines in any direction to be read in from the image sensor 6. As in the rectangle mode, a down-sampling factor can be defined in the horizontal and in the vertical direction also here.

The following parameters can be used to select the reading-in in parallelogram mode:

1. Number of parallelograms to be read in (in the represented example 1)

2. Horizontal coordinates Px of the first pixel (a corner pixel of the parallelogram) of each parallelogram

3. Vertical coordinates Py of the first pixel (a corner pixel of the parallelogram) of each parallelogram

4. Number a of read pixels between every read column in the horizontal direction

5. Number b of pixels in every read column

6. Number c of the read columns

7. Number d of unread pixels between every read line in the vertical direction

8. Number e of pixels in each read line

9. Number f of read lines

10. Shift g of the parallelogram in the horizontal direction; if the parameter g is negative, the parallelogram is oriented from bottom left to top right; with g=0, rectangular image shapes can be read in; if the parameter g is positive, the parallelogram is oriented from top left to bottom right, as in FIG. 8.

3. Extracting One or Several Ellipses in Ellipse Mode

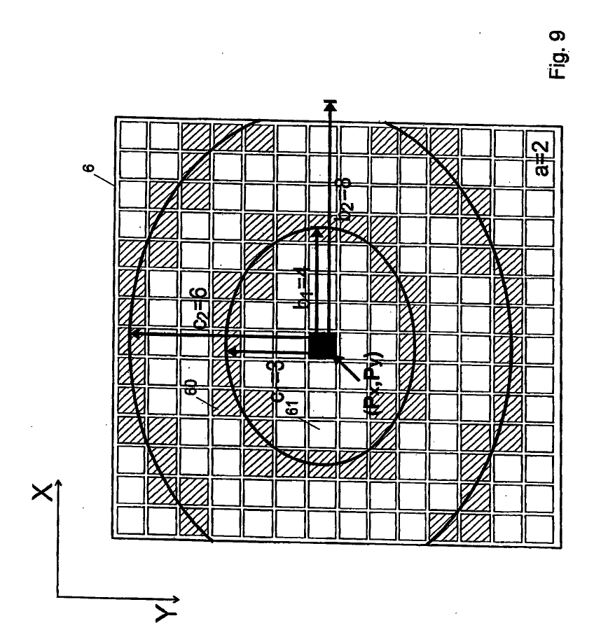

This reading-in mode is represented diagrammatically in FIG. 9. This mode allows, a certain number (1 up to a maximal number) of elliptical (for example circular) image sections to be read in from the image sensor 6. In the represented example, only concentric ellipses are defined. It would however also be possible to provide image recording orders with which not-concentric ellipses, in which a down-sampling factor in the horizontal and in the vertical direction is defined, can be indicated.

The following parameters can be used to select the reading-in in ellipse mode:

1. Number a of concentric ellipses to be read in (in the represented example 2)

2. Horizontal address Px of the center of all concentric ellipses

3. Vertical address Py of the center of all concentric ellipses

4. Number bi of the pixels in the large semi-axis of all ellipses

5. Number ci of the pixels in the small semi-axis of all ellipses

6. Optionally: orientation of the large semi-axis, if the latter is not horizontal

7. Optionally: down-sampling factor in the horizontal and in the vertical direction

A faster image reading in can be achieved if all ellipses are concentric and if the ratio of the small semi-axis to the large semi-axis during the image acquisition is the same for all ellipses.

Reading-In Mode Defined by the Image-Reading Unit

In order to unload further the memory unit 2 and the external device 3, it is also possible that the image-reading unit 1 defines itself the number, size, position, vertical and horizontal resolution and the shape of the read in image sections on the basis of more abstract orders. These parameters can also be adjusted dynamically (for example in real time and/or between each image). A program executed by the data processing means determines at any time which area of the image sensor 6 must be read in. The following conditions can cause adjustments of the image section:

Following of image object: the data processing means 8 of the image-reading unit 1 can carry out a tracking algorithm in order to identify and track a same object on successive images of an image sequence. The image-reading unit can extract from the image sensor and make available only the pixels belonging to the tracked object. The shape of the read-in image section can be adapted dynamically to the shape of the object and is not limited to rectangles, parallelograms and ellipses.

Adjustment to the optic: the resolution can be adjusted automatically to the quality of the optic, to the used focals, to the zoom factor, to the opening of the diaphragm, to the focus adjustment, etc.

Adjustment depending on the camera controlling orders: the image sections, in particular the resolution of the image sections, can be adjusted when for example zoom, panning or tilt movements are made or when the focus adjustment is changed automatically or manually.

Adjustment depending on triggers generated by external trigger devices: the camera can comprise an interface for receiving external trigger signals. The reading-in parameters can be changed automatically when a new trigger signal is received. In this manner, the reading-in conditions can be adapted to external events.

Adjustment depending on the contents of the image: the resolution, the read in image section etc. can automatically be adjusted dynamically when the content of the recorded images is changed. It is for example possible to automatically extract a new image section when an event is detected in this image section.

In order to react to events that occur in additional, not-extracted image sections, it is possible in one embodiment to read in these additional image sections with a slower sampling frequency and to use the additional image data thus obtained for watching events without having to make them available outside the image-reading unit.

With this image mode, the image modes can be communicated with an order as to which image section is needed. In a preferred embodiment, at least certain of the following parameters are entered in at least certain image recording orders:

Sampling time (100 ns, 200 ns, etc.); as an alternative or for certain orders, the order interpreter can always automatically select the fastest possible sampling time for the chosen image shape; as another variant, the same image area is always read and the image recording is clocked through the external synchronization signal 14.

Resolution of the analog-to-digital converter 7 (6, 8, 10 or 12 bit, etc.)

Integration time of the pixels (10 μs, 100 μs, 2 ms, etc.)

With or without electronic shutter

Control signals for a possible mechanical shutter

Control signals for the objective 4 such as zoom adjustment, iris and focus

Linear or logarithmic answer curve (read-out voltage as a function of the luminance) of the pixels

With or without image calibration (to limit the permanent noise, etc.)

With or without pre-processing of the image data to be read; the pre-processing can comprise algorithms such as edge detection, high pass and low pass filtering, etc.

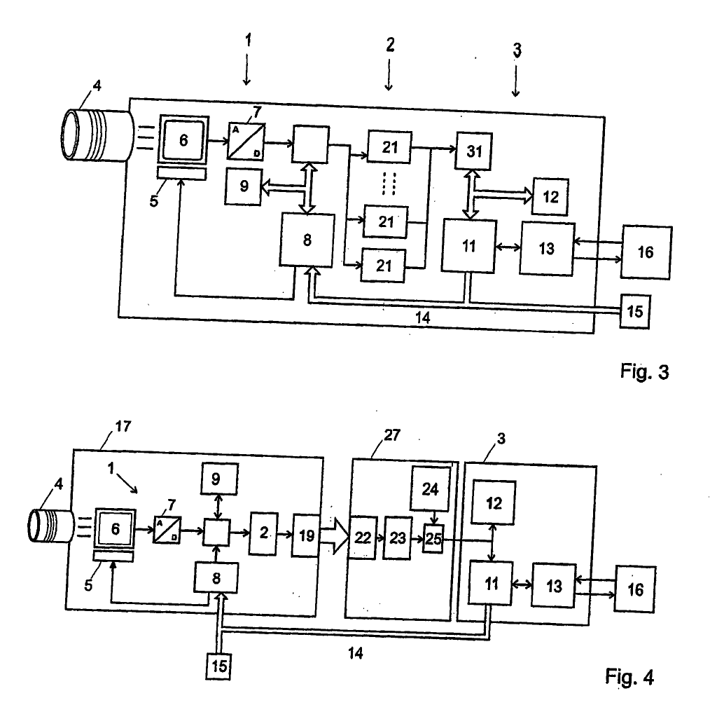

A second embodiment of an equipment according to the invention is represented in FIG. 3. In this variant, all the components previously described in relation to FIG. 2 are integrated within the same housing. Such a device can be designated an intelligent camera and can be connected with external devices 16 through an interface 13. Several of the components 8, 21, etc. described here can be integrated in a single integrated circuit.

A third embodiment of an equipment according to the invention is represented in FIG. 4. In this variant, the image-reading unit 1 and the memory unit 2 are integrated in a common housing 17. Such an equipment can be designated as single-pixel access camera. The image-reading unit comprises the same components as the variant of FIG. 2. Additionally to the image-reading unit 1 and to the memory unit 2, a communication interface 19 is implemented with a communication processor which makes it possible to send the image data from the single-pixel access camera 17 over a frame-grabber 27 (data receiving unit) to an external device 3. The external electronic equipment 3 can be a processor system (for example a PC) in which the frame-grabber card 27 is installed.

The image data read in by the image-reading unit are sent over a fast data bus to the frame-grabber 27. The frame-grabber 27 has a second communication interface with a communication processor 22 for receiving these data. The image data are then buffer-stored in a FIFO memory 23 and written over a direct memory access circuit (DMA) 24 and a communication interface 25 in the electronic memory 12 of the PC 3. The processor 11 of the PC 3 is thus used for the image signal processing itself. The image recording orders 14 can come from the processor 11 (over a communication interface 13) or also from an external equipment 15. Several of the components 8, 21, 19 etc. described here in the camera 17 can also be integrated in a single integrated circuit.

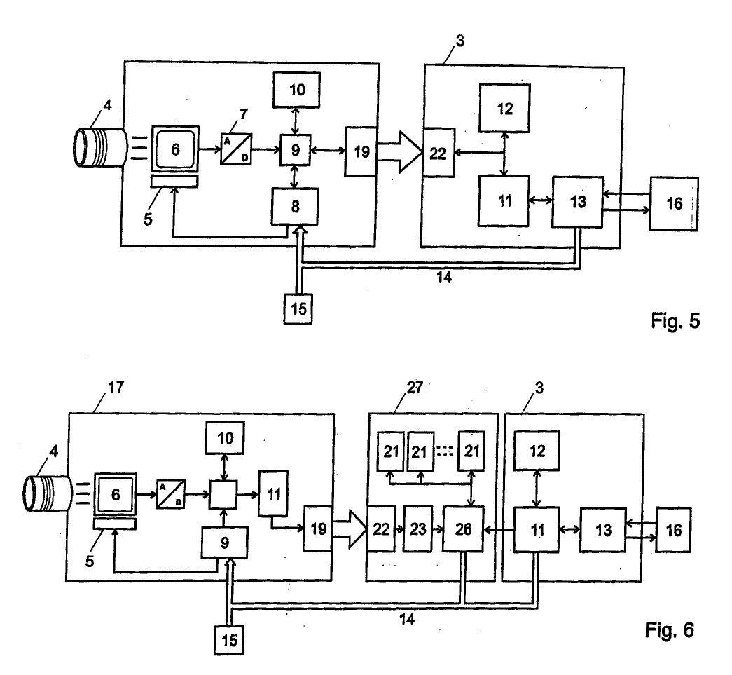

A fourth embodiment of an equipment according to the inventtion is represented in FIG. 5. In this variant embodiment, the external image processing unit 3 reads the selected image data not from a memory unit 2 but directly from the image-reading unit 1. For this purpose, the image-reading unit 1 has a suitable communication interface 19 that can access the memory unit 10 of the image-reading unit 1 directly. The communication processor 19 itself can further have a local memory. This processor sends the data over a communication interface 22 to the external equipment 3. The external equipment 3 is also provided with a communication processor 22 in order to receive the data correctly and to write them in an electronic memory 12. Further digital image processing means 11 are preferably provided for managing the image data and for sending them over a communication interface 13 to an external device 16.

A fifth embodiment of an equipment according to the invention is represented in FIG. 6. In this variant, a single-pixel access camera 17 is also used that sends the image data over a communication interface 19 to a frame-grabber 27. The frame-grabber 27 receives the selected image data and is connected with an external image processing unit 3. The image data are now received by a communication processor 22 in the frame-grabber 27 and can be buffer-stored in a FIFO memory 23. A processor 26 on the frame-grabber card 27 can process the received image data and write them in the local memory 21 of the frame-grabber 27. Preferably, the communication processor 22 can also write image data directly in the memory 21. In this manner, the processor 11 and the memory 12 of the external equipment 3 are unloaded. The processor 11 can if necessary access the image data of the frame-grabber 27 to process them further, to archive them, to send them over a network to a communication element 13 etc. and can also write these locally in its electronic memory 12.

Orders or synchronization signals 14 for image recording can either come from an external device 15, from the frame-grabber 27 or from an external device 3 or can be generated internally in the single-pixel access camera.

Apart from the new equipment 1, 2, for example in the form of a new intelligent camera, the invention also concerns new programs capable of being loaded in such a camera for interpreting and executing image recording orders in which the shape, the size, the position, the resolution and/or the number of image areas that are to be read in from an image sensor with single-pixel access. Such programs can be commercialized as computer products, in particular as programmed data carrier media. The invention also concerns programs that are executed by an external device 3, 14 for sending such orders to an electronic equipment according to the invention.

1. An electronic equipment comprising the following components:
an image-reading unit provided with one or several image sensors,
at least one image sensor allowing access to individual pixels of said image sensor,
said image-reading unit being designed in such a manner that it can receive and execute image recording orders,
the shape of the image section that is to be extracted from said image sensor being freely definable in at least one of said image recording orders
wherein said image-reading unit reads in and makes available only the image sections of said image sensor corresponding to the shape freely defined in said image recording order.

2. The electronic equipment of claim 1, with a memory unit writable by said image-reading unit and readable by an external electronic equipment for storing the image sections read in from said image sensor.

3. The electronic equipment of claim 1, wherein said image-reading unit is designed in such a manner that it can receive image recording orders from an external equipment.

4. The electronic equipment of claim 1, wherein said image-reading unit can generate image recording orders itself.

5. The electronic equipment of claim 1, wherein said image-reading unit is designed in such a manner that it can execute image recording orders containing image sections with several pixels.

6. The electronic equipment of claim 1, wherein the size, the position, the resolution and/or the number of image sections read in from said image sensor are freely definable in said image recording order.

7. The electronic equipment of claim 1, wherein said image-reading unit is designed in such a manner that it can interpret and execute orders for reading freely definable rectangular image sections from said image sensor.

8. The electronic equipment of claim 7, wherein said image-reading unit is designed in such a manner that it can interpret and execute orders for reading freely definable parallelograms from said image sensor.

9. The electronic equipment of claim 7, wherein said image-reading unit is designed in such a manner that it can interpret and execute orders for reading freely definable ellipses from said image sensor.

10. The electronic equipment of claim 1, wherein said image-reading unit is designed in such a manner that it can interpret and execute orders for reading freely definable rectangular image sections, parallelograms or ellipses from said image sensor.

11. The electronic equipment of claim 1, wherein said image-reading unit is designed in such a manner that it can interpret and execute orders for reading freely definable image sections with a freely definable resolution.

12. The electronic equipment of claim 1, wherein said image-reading unit is designed in such a manner that it can interpret and execute orders for reading a freely definable number of separate image sections.

13. The electronic equipment of claim 1, wherein said image-reading unit is designed in such a manner that it can itself adjust the shape, the position, the size, the resolution and/or the number of image sections read from the image sensor to the contents of the image.

14. The electronic equipment of claim 1, wherein said image reading unit is designed in such a manner that it can itself adjust the shape, the position, the size, the resolution and/or the number of image sections read from the image sensor to the optic.

15. The electronic equipment of claim 1, wherein said image-reading unit is designed in such a manner that it can itself adjust the shape, the position, the size, the resolution and/or the number of image sections read from the image sensor when external trigger signals are received.

16. The electronic equipment of claim 1, with a communication processor for making available the image data read from said image sensor to an external device.

17. The electronic equipment of claim 1, with data processing means for processing image data read from said image sensor.

18. The electronic equipment of claim 17, wherein said data processing means are designed in such a manner that they can perform at least certain of the following image processing operations: calibration with a calibration image, binarization with a threshold value, edge detection, filtering.

19. Computer program product that can be loaded in the memory of the electronic equipment of claim 1 and comprising software code portions for receiving image recording orders and for interpreting them in such a manner that only the image sections of an image sensor are addressed that correspond to the shape defined in these image recording orders.

20. Computer program product that can be loaded in the memory of an electronic equipment and comprising software code portions for generating image recording orders that are sent to electronic equipment of claim 1 for defining the shape of an image section that is to be made available by this equipment.
